(19) United States
(12) Patent Application Publication
(10) Pub. No.: US 2015/0021090 A1
(43) Pub. Date: Jan. 22, 2015

(54) TERMINAL-ATTACHED ELECTRIC WIRE

(71) Applicant: YAZAKI CORPORATION, Tokyo (JP)

(72) Inventors: Kazuki MANO, Susono-shi (JP); Tomokazu YOSHIDA, Susono-shi (JP); Kenji OSADA, Susono-shi (JP)

(73) Assignee: YAZAKI CORPORATION, Tokyo (JP)

(21) Appl. No.: 14/505,931

(22) Filed: Oct. 3, 2014

Related U.S. Application Data
(63) Continuation of application No. PCT/JP2013/060877, filed on Apr. 4, 2013.

(30) Foreign Application Priority Data
Apr. 4, 2012 (JP) 2012-085379
Apr. 4, 2012 (JP) 2012-085385

(51) Int. Cl. H01R 4/18; H01R 4/70; H01R 43/18; H01R 13/533; H01R 43/00; H01R 4/62; H01R 13/52

(52) U.S. Cl. CPC H01R 4/185; H01R 4/62; H01R 4/70; H01R 13/5216; H01R 13/533; H01R 13/52; H01R 43/005; H01R 43/18
USPC 174/72 A; 174/74 R; 29/858

(57) ABSTRACT

A terminal-attached electric wire of the invention includes an electric wire having a conductor and an electric wire cover member covering the conductor, and a crimping terminal connected to the conductor of the electric wire. The terminal-attached electric wire further includes a corrosion resistant member integrally formed with a peripheral portion of a joint section interposed between the conductor and the crimping terminal and a peripheral portion of the electric wire cover member adjacent to the joint section. The corrosion resistant member contains a thermoplastic elastomer as a main component. A peel strength of bonded assemblies between the corrosion resistant member and a terminal member of the crimping terminal is equal to or greater than 0.2 N/mm, and a peel strength of bonded assemblies between the corrosion resistant member and the electric wire cover member is equal to or greater than 0.5 N/mm.

### CROSS REFERENCE TO RELATED APPLICATIONS

This application is a continuation of PCT application No. PCT/JP2013/060877, which was filed on Apr. 4, 2013 based on Japanese patent application (patent application 2012-085379) filed on Apr. 4, 2012, and Japanese patent application (patent application 2012-085385) filed on Apr. 4, 2012, whose contents are incorporated herein by reference. Also, all the references cited herein are incorporated as a whole.

### BACKGROUND OF THE INVENTION

1. Technical Field

The present invention relates to a terminal-attached electric wire. To be specific, the invention relates to a terminal-attached electric wire which is configured such that a corrosion resistant member is provided at a peripheral portion of a joint section interposed between a conductor of a wire and a crimping terminal.

2. Background Art

In recent years, from a viewpoint of improving fuel consumption by virtue of reduction of weight of a vehicle, the number of cases is increasing that aluminum is used for a covered electric wire constituting a wire harness. In general, copper or copper alloy excellent in electric property is used for a terminal metal fixture to be connected to the covered electric wire such as above described. However, when materials of a conductor of the covered electric wire and a terminal metal fixture are different from each other, corrosion may occur on a contact section interposed between the conductor and the terminal metal fixture. Therefore, it is necessary to use a corrosion resistant member capable of preventing the contact section from being corroded.

For this reason, materials having, as a main component, a thermoplastic polyamide resin of which the tensile shear strength, the extension coefficient and the water absorption coefficient satisfy predetermined values, have been disclosed as the corrosion resistant member, heretofore (see, for example, Japanese Patent Publication No. JP-A-2011-103266). In Patent Literature 1, the corrosion resistant member is applied to a joint section interposed between a conductor of a covered terminal-attached electric wire and a terminal metal fixture, thereby preventing the conductor and the terminal metal fixture from being corroded.

### SUMMARY

In a covered terminal-attached electric wire of Japanese Patent Publication No. JP-A-2011-103266, a corrosion resistant member made of a thermoplastic polyamide resin is applied to a joint section interposed between a conductor and a terminal metal fixture so as to form a coating film of the corrosion resistant member. Therefore, the thickness of the corrosion resistant member becomes ununiform, which may cause a problem that a corrosion resistant performance is instable.

The invention is made in view of the above problem existed in a related art. The purpose of the invention is to provide a terminal-attached electric wire which is configured to prevent corrosion from occurring on a joint section interposed between an electric wire and a crimping terminal for a long time period.

A terminal-attached electric wire according to a first aspect of the invention includes an electric wire having a conductor and an electric wire cover member covering the conductor, and a crimping terminal connected to the conductor of the electric wire. The terminal-attached electric wire further includes a corrosion resistant member which is integrally formed with a peripheral portion of a joint section interposed between the conductor and the crimping terminal and a peripheral portion of the electric wire cover member adjacent to the joint section, and a primer which is provided at an interspace between the corrosion resistant member and the joint section interposed between the conductor and the crimping terminal. The corrosion resistant member has a thermoplastic elastomer as a main component. In addition, a peel strength of bonded assemblies between the corrosion resistant member and a terminal member of the crimping terminal is equal to or greater than 0.2 N/mm and a peel strength of bonded assemblies between the corrosion resistant member and the electric wire cover member is equal to or greater than 0.5 N/mm.

The terminal-attached electric wire according to a second aspect of the invention is configured such that the conductor in the terminal-attached electric wire according to the first aspect is made of aluminum or aluminum alloy, the terminal member of the crimping terminal is made of at least copper, copper alloy, stainless steel, tin plated copper, tin plated copper alloy and tin plated stainless steel, and the electric wire cover member is made of at least one of polyethylene, polypropylene, ethylene copolymer and propylene copolymer.

The terminal-attached electric wire according to a third aspect of the invention is configured such that the primer of the terminal-attached electric wire according to the first aspect contains, as a main component, at least one of an olefin resin, an amine compound, a silane coupling material and an epoxy-based component.

A wire harness according to a fourth aspect of the invention includes the terminal-attached electric wire according to the first aspect.

A method of manufacturing a terminal-attached electric wire according to a fifth aspect of the invention includes a process of connecting an electric wire having a conductor and an electric wire cover member covering the conductor to a crimping terminal connected to the conductor of the electric wire, a process of applying a primer to a joint section interposed between the conductor and the crimping terminal, and a process of forming a corrosion resistant member at a peripheral portion of the joint section interposed between the conductor and the crimping terminal and a peripheral portion of the electric wire cover member adjacent to the joint section by injection molding, the joint section being coated with the primer. The corrosion resistant member has a thermoplastic elastomer as a main component. In addition, a peel strength of bonded assemblies between the corrosion resistant member and a terminal member of the crimping terminal is equal to or greater than 0.2 N/mm and a peel strength of bonded assemblies between the corrosion resistant member and the electric wire cover member is equal to or greater than 0.5 N/mm.

The terminal-attached electric wire according to a sixth aspect of the invention includes an electric wire having a conductor and an electric wire cover member covering the conductor, a crimping terminal connected to the conductor of the electric wire, and a corrosion resistant member integrally formed with a peripheral portion of a joint section interposed between the conductor and a crimping terminal and a peripheral portion of the electric wire cover member adjacent to the joint section.

The corrosion resistant member has a thermoplastic elastomer as a main component. In addition, a peel strength of bonded assemblies between the corrosion resistant member and a terminal member of the crimping terminal is equal to or greater than 0.2 N/mm and a peel strength of bonded assemblies between the corrosion resistant member and the electric wire cover member is equal to or greater than 0.5 N/mm.

The terminal-attached electric wire according to a seventh aspect of the invention is configured such that the conductor in the terminal-attached electric wire according to the first aspect is made of aluminum or aluminum alloy, the terminal member of the crimping terminal is made of at least copper, copper alloy, stainless steel, tin plated copper, tin plated copper alloy and tin plated stainless steel, and the electric wire cover member is made of polyvinyl chloride (PVC).

A wire harness according to a eighth aspect of the invention includes the terminal-attached electric wire according to the first aspect.

A method of manufacturing a terminal-attached electric wire according to a ninth aspect of the invention includes a process of connecting an electric wire having a conductor and an electric wire cover member covering the conductor to a crimping terminal connected to the conductor of the electric wire, a process of applying a primer to a joint section interposed between the conductor and the crimping terminal, and a process of forming a corrosion resistant member at a peripheral portion of the joint section interposed between the conductor and the crimping terminal and a peripheral portion of the electric wire cover member adjacent to the joint section by injection molding, the joint section being coated with the primer. The corrosion resistant member has a thermoplastic elastomer as a main component. In addition, a peel strength of bonded assemblies between the corrosion resistant member and a terminal member of the crimping terminal is equal to or greater than 0.2 N/mm and a peel strength of bonded assemblies between the corrosion resistant member and the electric wire cover member is equal to or greater than 0.5 N/mm.

In accordance with the terminal-attached electric wire of the invention, it is possible to prevent a corrosion causing substance from entering into the electric wire through contact interfaces between the corrosion resistant member and the crimping terminal as well as between the corrosion resistant member and the electric wire cover member. Therefore, even in a case where the conductor of the electric wire and the electric wire cover member are formed of different metallic materials, it is possible to prevent corrosion from occurring on the joint section interposed between the conductor of the electric wire and the crimping terminal for a long time period. In addition, a primer may be provided at an interspace between the corrosion resistant member and the joint section interposed between the conductor of the electric wire and the crimping terminal. Therefore, it is possible to improve an adhesion property between the crimping terminal and the corrosion resistant member, and thereby it is possible to further prevent a corrosion causing substance from entering into the electric wire.

In addition, since the terminal-attached electric wire of the invention is configured such that the corrosion resistant member is formed by injection molding, a shape and a thickness of the corrosion resistant member can be stabilized. As a result, even when the thickness of the corrosion resistant member is small, it is possible to ensure the sufficient strength. Moreover, since the thickness of the corrosion resistant member can be reduced, it is possible to insert the terminal-attached electric wire of the invention into a connector housing having a conventional size, so that it is not necessary to change a design of the connector housing.

### BRIEF DESCRIPTION OF THE DRAWINGS

FIGS. 1A and 1B are schematic views showing a terminal-attached electric wire according to an embodiment of the invention. FIG. 1A is a perspective view showing the terminal-attached electric wire, and FIG. 1B is a side view showing a part of the terminal-attached electric wire.

FIG. 2 is a cross sectional view taken along a line A-A in FIG. 1B.

FIG. 3 is a schematic view showing a state in which the electric wire is not yet connected to the crimping terminal in the terminal-attached electric wire according to the embodiment of the invention.

FIG. 4 is a schematic view showing a state in which the electric wire is connected to the crimping terminal in the terminal-attached electric wire according to the embodiment of the invention.

FIG. 5 is a perspective view showing a state in which the primer is applied to the joint section interposed between the conductor of the electric wire and the crimping terminal in the terminal-attached electric wire according to the embodiment of the invention.

FIG. 6 is a perspective view showing a wire harness according to an embodiment of the invention.

FIG. 7 is a schematic view explanatorily showing an estimation method of a corrosion resistant performance.

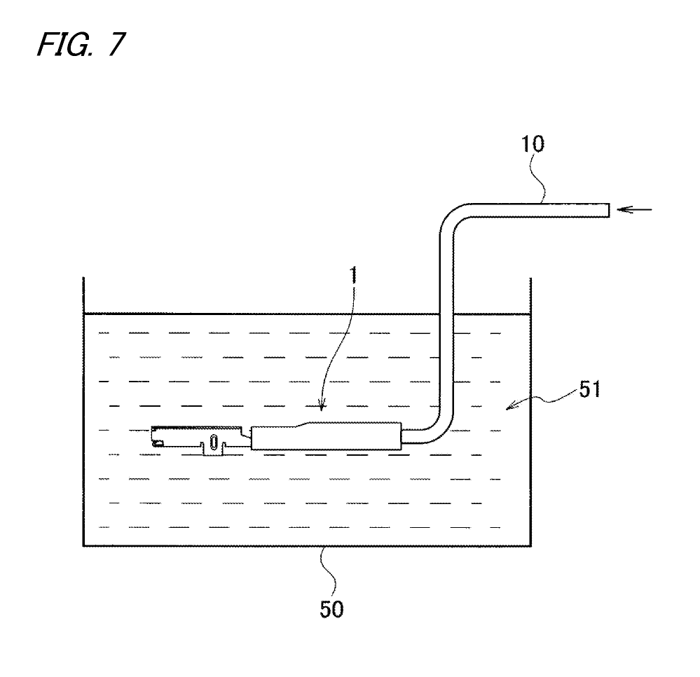

FIG. 8 is a cross sectional view of a terminal-attached electric wire according to a second embodiment of the invention.

### DETAILED DESCRIPTION OF EMBODIMENTS

Embodiments of the invention will be described below in detail with reference to the accompanying drawings. Meanwhile, the dimensional proportions in the drawings are modified for convenience of explanation so that they may be different from the actual proportions.

### First Embodiment

Terminal-Attached Electric Wire:

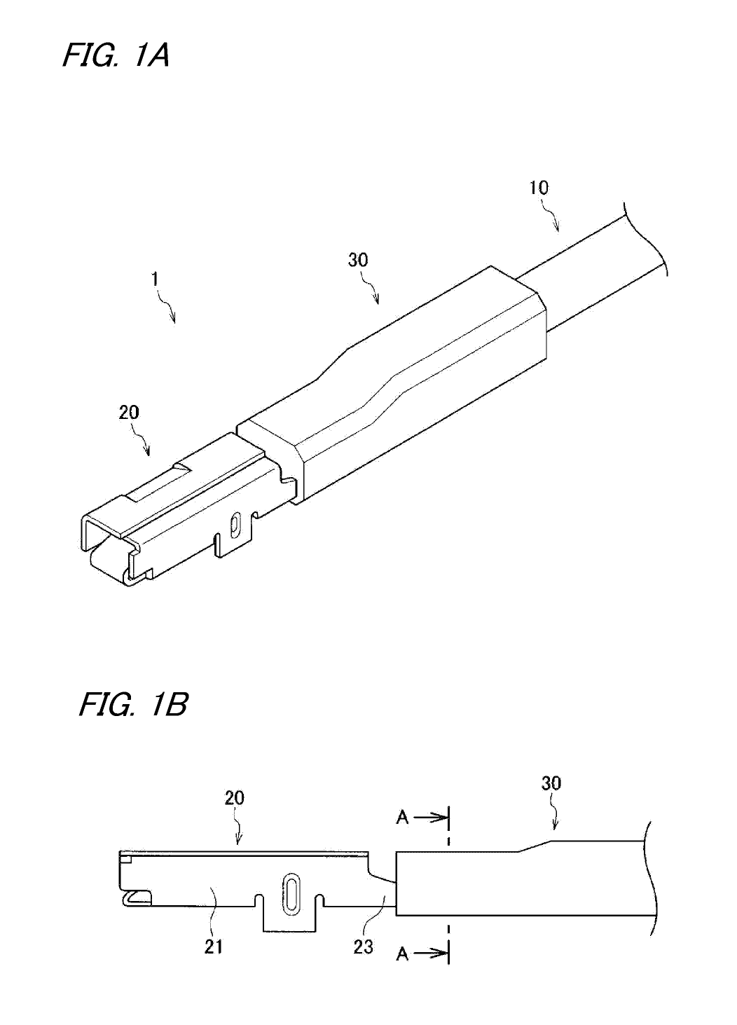

As shown in FIGS. 1 to 4, a terminal-attached electric wire 1 according to this embodiment includes an electric wire 10 having a conductor 11 and an electric wire cover member 12, and a crimping terminal 20 connected to the conductor 11 of the electric wire 10. The terminal-attached electric wire 1 further includes a corrosion resistant member 30 which is integrally formed with a peripheral portion of a joint section interposed between the conductor 11 and the crimping terminal 20 and a peripheral portion of the electric wire cover member 12 adjacent to the joint section. In addition, a primer 31 is provided at an interspace between the corrosion resistant member 30 and the joint section interposed between the conductor 11 and the crimping terminal 20.

The crimping terminal 20 on the terminal-attached electric wire 1 is of a female type and has, at its front portion, an electric connection section 21 to be connected to a counter terminal (not shown). The electric connection section 21 stores a spring piece to be engaged with a counter terminal and has a box-like shape. In addition, the crimping terminal 20 has, at its rear portion, an electric wire joint section 22 which is to be connected to a terminal portion of the electric wire 10 via a coupling section 23 by caulking.

The electric wire joint section 22 has a conductor crimping section 24 placed at its front side and a cover member caulking section 25 placed at its rear side.

The conductor crimping section 24 at the front side is adapted to be directly contacted to the conductor 11 which is exposed by removing the electric wire cover member 12 of the electric wire 10 at the terminal portion. The conductor crimping section 24 has a bottom plate section 26 and a pair of conductor caulking pieces 27. The pair of conductor caulking pieces 27 are allowed to extend upward from both side edges of the bottom plate section 26, respectively. By bending the pair of conductor caulking pieces 27 inside so as to wrap the conductor 11 of the electric wire 10, the conductor 11 is caulked to be put into a state in which it is in intimate contact with a top face of the bottom plate section 26. The conductor crimping section 24 is formed in a roughly U-shape in a cross sectional view by the bottom plate section 26 and the pair of conductor caulking pieces 27.

In addition, the cover member caulking section 25 is adapted to be directly contacted to the electric wire cover member 12 of the electric wire 10 at the terminal portion. The cover member caulking section 25 has a bottom plate section 28 and a pair of cover member caulking pieces 29. The cover member caulking pieces 29 are allowed to extend upward from both side edges of the bottom plate section 28, respectively. By bending the pair of cover member caulking pieces 29 inside so as to wrap a portion of the electric wire 10 at the terminal portion, the portion having the electric wire cover member 12 attached thereto, the electric wire cover member 12 is caulked to be put into a state in which it is in intimate contact with a top face of the bottom plate section 28. The cover member caulking section 25 is formed in a roughly U-shape in a cross sectional view by the bottom plate section 28 and the pair of cover member caulking pieces 29. Here, a part from the bottom plate section 26 of the conductor crimping section 24 to the bottom plate section 28 of the cover member caulking section 25 is continuously formed as a common bottom plate.

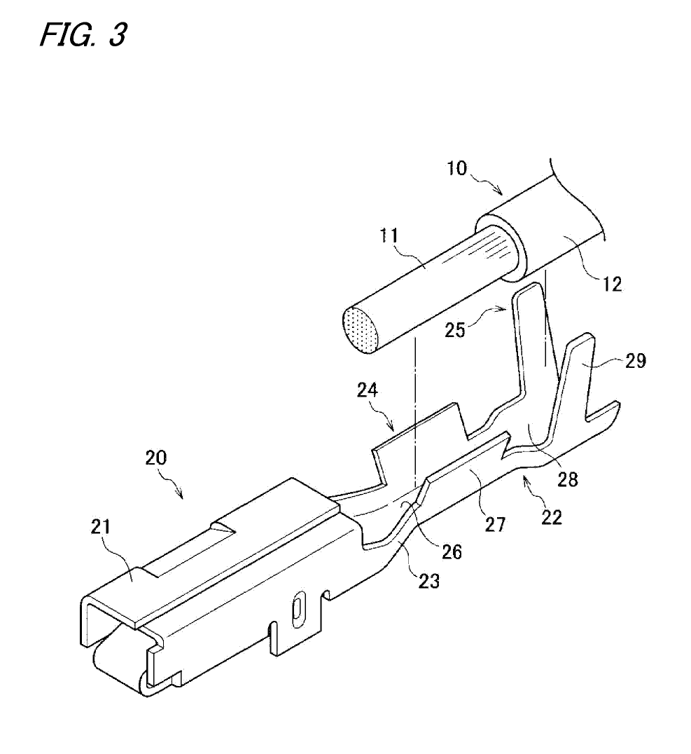

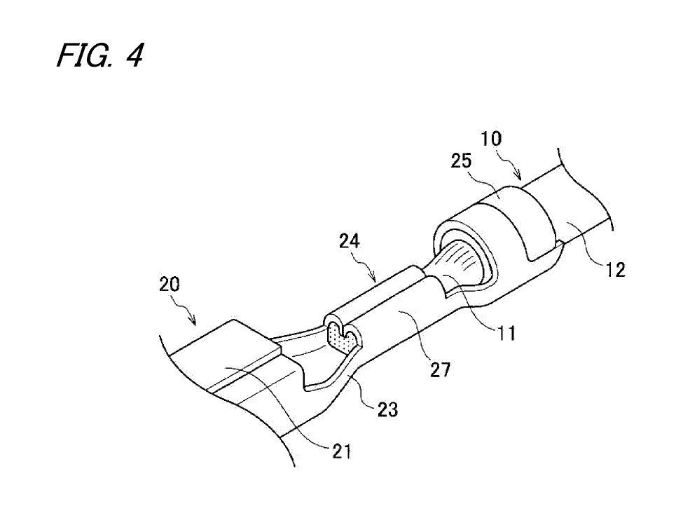

In the embodiment, the terminal portion of the electric wire 10 is inserted into the electric wire joint section 22 of the crimping terminal 20 having the above described structure, as shown in FIGS. 3 and 4. With this, the conductor 11 of the electric wire 10 is placed on the top face of the bottom plate section 26 of the conductor crimping section 24, and the portion of the electric wire 10 having the electric wire cover member 12 attached thereto is placed on the top face of the bottom plate section 28 of the cover member caulking section 25. By pressing the electric wire joint section 22 and the terminal portion of the electric wire 10, the conductor crimping section 24 and the cover member caulking section 25 are deformed. That is, by bending the pair of conductor caulking pieces 27 of the conductor crimping section 24 inside so as to wrap the conductor 11, the conductor 11 is caulked to be put into a state in which the conductor 11 is in intimate contact with the top face of the bottom plate section 26. In addition, by bending the pair of cover member caulking pieces 29 of the cover member caulking section 25 inside so as to wrap the portion of the wire 10 having the electric wire cover member 12 attached thereto, the electric wire cover member 12 is caulked to be put into a state in which the electric wire cover member 12 is in intimate contact with the top face of the bottom plate section 28. In accordance with the above described operations, the crimping terminal 20 and the electric wire 10 can be connected to each other by crimping.

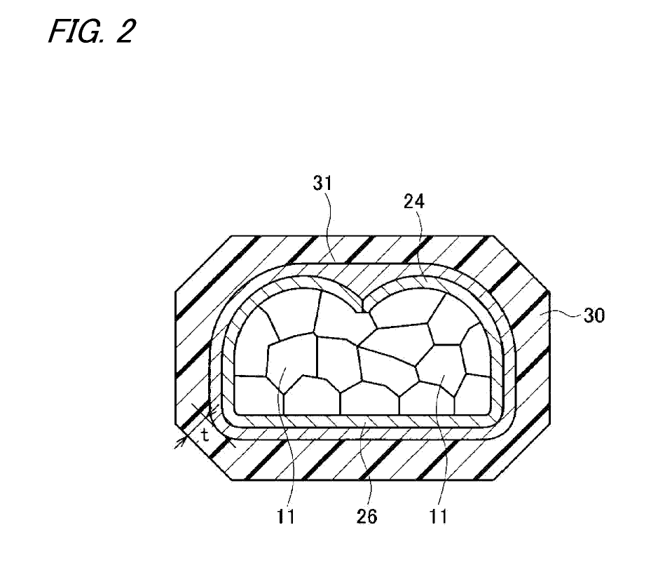

In the embodiment, as shown in FIG. 1, peripheral portions of the coupling section 23, the electric wire joint section 22, the conductor 11 covered with the electric wire joint section 22 and the electric wire cover member 12 are covered with the corrosion resistant member 30. That is, the corrosion resistant member 30 straddles a border between the conductor crimping section 24 and a tip portion of the conductor 11 of the electric wire 10 so as to also cover a part of the coupling portion 23, and it straddles a border between the cover member caulking section 25 and the electric wire cover member 12 so as to also cover a part of the electric wire cover member 12. A material adhering to both of the crimping terminal 20 and the electric wire cover member 12 is integrally formed with a terminal joint portion of the electric wire 10 so as to form the corrosion resistant member 30. Thus, the peripheral portions of the conductor 11 covered with the electric wire joint section 22 and the electric wire cover member 12 are completely covered with the corrosion resistant member 30 so that it is possible to surely ensure a corrosion resistant performance at a contact portion interposed between the conductor 11 and the electric wire joint section 22. Meanwhile, the corrosion resistant member 30 is formed to have a roughly rectangular cross sectional shape as shown in FIG. 2 and it can be attached to a terminal storage section of a connector housing (described later) together with the electric connection section 21.

Here, it is preferable that the corrosion resistant member 30 contains a thermoplastic elastomer as a main component. By using the above described material for the corrosion resistant member 30, the corrosion resistant member 30 can be intimately contacted with the crimping terminal 20 and the electric wire cover member 12. Therefore, it is possible to prevent chloride ion or moisture as a cause of corrosion from entering into the electric wire 10 through contact interfaces between the corrosion resistant member 30 and the crimping terminal 20 as well as between the corrosion resistant member 30 and the electric wire cover member 12. As a result, it is possible to effectively prevent corrosion from occurring on the joint section interposed between the electric wire joint section 22 of the crimping terminal 20 and the conductor 11. In the specification, a component of which the weight percentage of the entirety of the corrosion resistant member 30 is equal to or greater than 50 is referred to as the main component.

To be specific, it is preferable that a thermoplastic olefin-based elastomer is used for the thermoplastic elastomer forming the corrosion resistant member 30.

In order to prevent chloride ion or moisture as a corrosion causing substance from entering into the electric wire 10, it is necessary that a peel strength of bonded assemblies between the corrosion resistant member 30 and the terminal member of the crimping terminal 20 is equal to or greater than 0.2 N/mm and a peel strength of bonded assemblies between the corrosion resistant member 30 and the electric wire cover member 12 is equal to or greater than 0.5 N/mm. The word of “peel strength of bonded assemblies” in this specification is a value obtained by a measuring method specified in Japanese Industrial Standards K6854-3 (Adhesives—Determination of peel strength of bonded assemblies—Part 3: T-peel test). When the above described material is used for the corrosion resistant member 30 as a main component and the peel strengths of bonded assemblies between the corrosion resistant member 30 and the terminal member of the crimping terminal 20 as well as between the corrosion resistant member 30 and the electric wire cover member 12 are two times or more of the above described value, it is possible to retain high adhesion forces at contact interfaces between the corrosion resistant member 30 and the crimping terminal 20 as well as between the corrosion resistant member 30 and the electric wire cover member 12. As a result, it is possible to sufficiently ensure a sealing property at the contact interfaces so that it is possible to prevent a corrosion causing substance from entering into the electric wire 10.

Meanwhile, there is no particular upper limitation on the peel strength of bonded assemblies between the corrosion resistant member 30 and the terminal member of the crimping terminal 20 or the peel strength of bonded assemblies between the corrosion resistant member 30 and the electric wire cover member 12. However, in a case where a strength of the terminal member of the crimping terminal 20 is lower than the peel strength of bonded assemblies between the corrosion resistance member 30 and the terminal member of the crimping terminal 20, there is a risk that the crimping terminal 20 may be damaged. Therefore, it is preferable that the peel strength of bonded assemblies between the corrosion resistant member 30 and the terminal member of the crimping terminal 20 is lower than the strength of the terminal member of the crimping terminal 20. Similarly to the above, in a case where a strength of the electric wire cover member 12 is lower than the peel strength of bonded assemblies between the corrosion resistant member 30 and the electric wire cover member 12, there is a risk that the electric wire cover member 12 may be damaged and the conductor 11 may be exposed. Therefore, it is preferable that the peel strength of bonded assemblies between the corrosion resistant member 30 and the electric wire cover member 12 is lower than the strength of the electric wire cover member 12.

Here, while metal having excellent electric conductivity can be used for a material of the conductor 11 of the electric wire 10, copper, copper alloy, aluminum or aluminum alloy, for example, can be used. In recent years, from a viewpoint that weight reduction of a wire harness is expected, it is preferable that aluminum or aluminum alloy with light weight is used for the conductor 11.

In addition, while a resin capable of ensuring electric insulating property can be used for a material of the electric wire cover member 12 covering the conductor 11, an olefin-based resin, for example, can be used. To be specific, at least one of polyethylene, polypropylene, ethylene copolymer and propylene copolymer, for example, can be used as a main component. In those materials, it is preferable that the electric wire cover member 12 is made of polypropylene. Since polypropylene has a high bonding force with respect to the thermoplastic elastomer, it is possible to enhance the adhesion force at the contact interface between the electric wire cover member 12 and the corrosion resistant member 30. Meanwhile, a component of which the weight percentage is equal to or greater than 50 in the entirety of the electric wire cover member 12 is referred to as the main component in the above description.

In addition, while metal having excellent electric conductivity can be used for a material (the terminal member) of the crimping terminal 20, at least one of copper, copper alloy, stainless steel, tin plated copper, tin plated copper alloy and tin plated stainless steel, for example, can be used. Moreover, at least one of gold plated copper, gold plated copper alloy and gold plated stainless steel can be used, as well as at least one of silver plated copper, silver plated copper alloy and silver plated stainless steel can be used. In those materials, it is preferable that copper, copper alloy or stainless steel having a surface plated with tin (Sn) is used. Since the thermoplastic elastomer has a high bonding force with respect to tin, it is possible to enhance the adhesion force at the contact interface between the crimping terminal 20 and the corrosion resistant member 30.

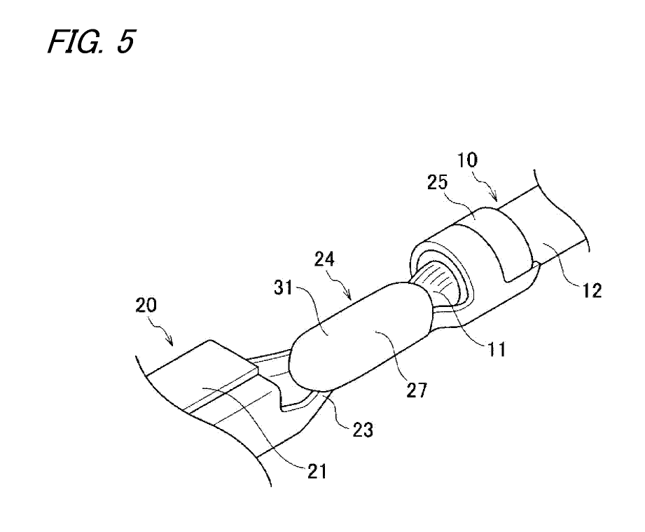

As shown in FIGS. 2 and 5, the terminal-attached electric wire 1 of the embodiment is configured such that the primer 31 is provided at an interspace between the corrosion resistance member 30 and the joint section interposed between the conductor 11 and the crimping terminal 20. By providing the primer 31, it is possible to improve the adhesion property between the corrosion resistant member 30 and the conductor crimping section 24 of the crimping terminal 20 or the conductor 11 of the electric wire 10.

As shown in FIGS. 2 and 5, the primer 31 can be applied to cover entire peripheral portions of the conductor crimping section 24 of the crimping terminal 20 and the bottom plate section 26 or the tip portion of the conductor 11 exposed at the front side of the conductor crimping section 24. Further, the primer 31 can be applied to cover the conductor 11 exposed between the conductor crimping section 24 and the cover member caulking section 25. Moreover, the primer 31 can be applied to cover the entire peripheral portion of the cover member caulking section 25 of the crimping terminal 20.

While any material can be used for the primer 31 as long as it can cause the adhesion property between the crimping terminal 20 and the corrosion resistant member 30 to be improved, it is preferable that the primer 31 contains, as a main component, at least one of, for example, an olefin resin, an amine compound, a silane coupling material and an epoxy-based component. These materials have a high bonding force with respect to copper, copper alloy, stainless steel, tin plated copper, tin plated copper alloy or tin plated stainless steel which is used for the terminal member of the crimping terminal 20. Further, the materials have a high bonding force with respect to a thermoplastic elastomer which can be used for the corrosion resistant member 30. Therefore, the adhesion property between the crimping terminal 20 and the corrosion resistant member 30 can be more improved with the use of the primer 31 so that it is possible to prevent a corrosion causing substance from entering into the electric wire 10, and thereby it is possible to prevent corrosion from occurring on the joint section interposed between the conductor 11 and the crimping terminal 20 for a long time period. Meantime, a component of which the weight percentage of the entirety of the primer 31 is equal to or greater than 50 is referred to as the main component in the above description.

As shown in FIG. 2, it is preferable that a thickness t of the corrosion resistant member 30 which is integrally formed with the peripheral portion of the joint section interposed between the conductor 11 and the crimping terminal 20 and the peripheral portion of the electric wire cover member 12 adjacent to the joint section, is at least equal to or greater than 0.01 mm. In a case where a sufficient sealing property is ensured at the interspaces between the corrosion resistant member 30 and the crimping terminal 20 as well as between the corrosion resistant member 30 and the electric wire cover member 12, the thickness t of the corrosion resistant member 30 can be less than 0.01 mm. However, when the thickness t of the corrosion resistant member 30 at a thinnermost portion is equal to or greater than 0.01 mm, it is possible to retain a sufficient strength with respect to an inner pressure of an inner section of the corrosion resistant member 30. Therefore, it is possible to prevent a corrosion causing substance from entering into the electric wire 10 for a long time period so that it is possible to prevent corrosion from occurring on the joint section interposed between the conductor 11 and the crimping terminal 20.

Thus, the terminal-attached electric wire 1 according to the embodiment is configured such that the corrosion resistant member is integrally formed with the peripheral portion of the joint section interposed between the conductor and the crimping terminal and the peripheral portion of the electric wire cover member adjacent to the joint section. In addition, the primer is provided at the interspace between the corrosion resistant member and the joint section interposed between the conductor and the crimping terminal. Further, the corrosion resistant member contains the thermoplastic elastomer as a main component. Moreover, the peel strength of bonded assemblies between the corrosion resistant member and the terminal member of the crimping terminal is equal to or greater than 0.2 N/mm, and the peel strength of bonded assemblies between the corrosion resistant member and the electric wire cover member is equal to or greater than 0.5 N/mm. With this, even in a case where the conductor of the electric wire and the crimping terminal are made of different metallic materials, it is possible to prevent corrosion from occurring on these components. That is, since it is possible to prevent a corrosion causing substance from entering into the electric wire through the contact interfaces between the corrosion resistant member and the crimping terminal as well as between the corrosion resistant member and the electric wire cover member, it is possible to prevent corrosion from occurring on the joint section interposed between the conductor and the crimping terminal for a long time period.

Method of manufacturing terminal-attached electric wire:

Next, a method of manufacturing a terminal-attached electric wire according to the embodiment will be described below. As shown in FIGS. 3 and 4, the terminal-attached electric wire 1 is first formed in such a manner that the terminal portion of the electric wire 10 is inserted into the electric wire joint section 22 of the crimping terminal 20. After that, the conductor 11 of the electric wire 10 is placed on the top face of the bottom plate section 26 of the conductor crimping section 24, and the portion of the electric wire 10 having the electric wire cover member 12 attached thereto is placed on the top face of the bottom plate section 28 of the cover member caulking section 25. By bending the pair of conductor caulking pieces 27 of the conductor crimping section 24 inside, the conductor 11 is caulked to be put into a state in which the conductor 11 is in intimate contact with the top face of the bottom plate section 26. In addition, by bending the pair of cover member caulking pieces 29 of the cover member caulking section 25 inside, the electric wire cover member 12 is caulked to be put into a state in which the electric wire cover member 12 is in intimate contact with the top face of the bottom plate section 28. Accordingly, the crimping terminal 20 and the electric wire 10 can be connected to each other.

Next, the joint section interposed between the crimping terminal 20 and the electric wire 10 is placed on a metallic mold. After that, a primer is thrown into the metallic mold so that the primer is applied to surfaces of the conductor crimping section, the cover member caulking section 25 and the conductor 11 at the crimping terminal 20. Meanwhile, at that time, applying can be carried out by using a nozzle or the like and ejecting the primer therefrom. In addition, before the joint section interposed between the crimping terminal 20 and the electric wire 10 is placed on the metallic mold, the primer can be applied to the surfaces of the conductor crimping section 24, the cover member caulking section 25 and the conductor 11 by using a brush or the like.

After applying of the primer is carried out, the inner section of the metallic mold is filled with a resin of a corrosion resistant member which is melted by heating, and the metallic mold is cooled so as to solidify the melted resin of the corrosion resistant member. By taking it out from the metallic mold, it is possible to obtain the terminal-attached electric wire 1 configured such that the joint section interposed between the crimping terminal 20 and the electric wire 10 is covered with the corrosion resistant member 30. That is, the corrosion resistant member 30 can be formed in such a manner that the joint section interposed between the crimping terminal 20 and the electric wire 10 is placed on the metallic mold and is subjected to injection molding.

Thus, regarding the terminal-attached electric wire 1 according to the embodiment, the corrosion resistant member is formed by the injection molding. Therefore, since the shape and the thickness of the corrosion resistant member are stabilized, it is possible to retain a sufficient strength even when the thickness of the corrosion resistant member is small. In addition, since the thickness of the corrosion resistant member can be reduced, it is not necessary to change a pitch dimension of a connector housing (described later), and thereby it is possible to insert the terminal-attached electric wire 1 according to the embodiment into a connector housing having a conventional size. Consequently, it is not necessary to change a design of the connector housing for the terminal-attached electric wire 1 according to the embodiment.

Wire Harness:

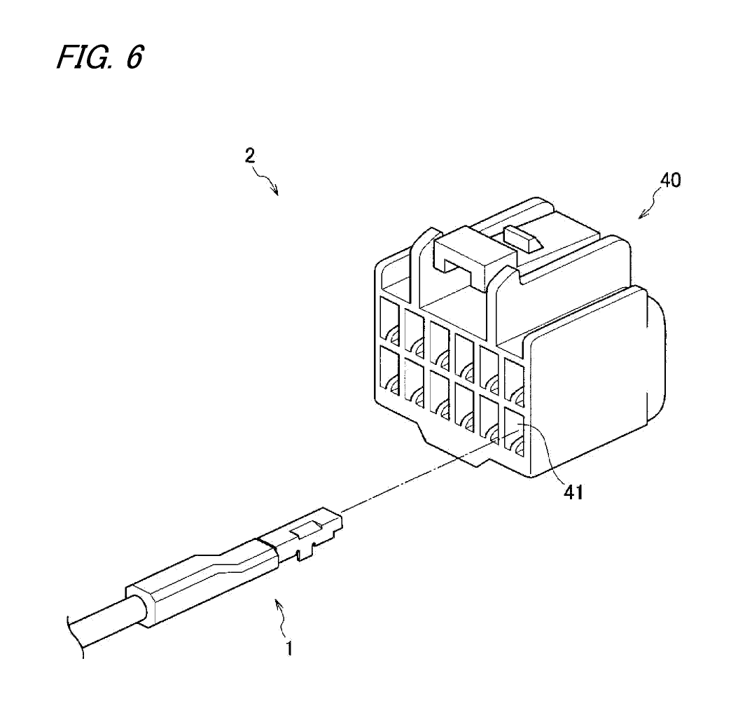

A wire harness of this embodiment is provided with the above described terminal-attached electric wire 1. To be specific, a wire harness 2 according to the embodiment is provided with a connector housing 40 and the above described terminal-attached electric wires 1 as shown in FIG. 6.

A plurality of counter-side terminal attachment sections (not shown) to which counter-side terminals (not shown) are to be attached, are provided at a front face side of the connector housing 40. A plurality of terminal storage sections 41 are provided at a back face side of the connector housing 40. The crimping terminal 20 and the corrosion resistant member 30 in the terminal-attached electric wire 1 are attached to each of the terminal storage sections 41. The crimping terminals 20 are attached to the connector housing 40 and the electric wires 10 are drawn from the back face side of the connector housing 40.

As described in the above, since the thickness of the corrosion resistant member 30 in the terminal-attached electric wire 1 according to the embodiment can be reduced, it is not necessary to dare to change the pitch dimension of the connector housing 40. Therefore, the terminal-attached electric wire 1 according to the embodiment can be inserted into a connector housing having a conventional size so that it is not necessary to dare to change a design of the connector housing for the above described terminal-attached electric wire 1.

### EXAMPLES

The invention is described below in detail on the basis of practical examples and comparison examples. However, the invention is not limited by the practical examples.

### Practical Examples

Regarding practical examples 1-1 to 1-3 and 2-1 to 2-3, materials for the corrosion resistant member 30 and the primer 31 shown in Table 1 and Table 2 were first prepared. An electric wire having a conductor made of aluminum and an electric wire cover member made of polypropylene (pp) was prepared. A crimping terminal with the use of tin plated copper as a terminal member was prepared.

Next, the electric wire 10 and the crimping terminal 20 were connected to each other, and then a joint section interposed between the crimping terminal 20 and the electric wire 10 was placed on a metallic mold. The primer 31 was applied to entire peripheral portions of the conductor crimping section 24 and the bottom plate section 28 of the crimping terminal 20, and was solidified. After that, the inner section of the metallic mold was filled with a material of the corrosion resistant member 30 of each practical example, the material being melted by heating, and the metallic mold was cooled, and thereby the melted material of the corrosion resistant member 30 was solidified. By taking it out from the metallic mold, the terminal-attached electric wire 1 of each practical example was obtained. Meanwhile, in Tables 1 and 2, a peel strength of bonded assemblies between the corrosion resistant member 30 to the terminal member (tin) of the crimping terminal 20 and a peel strength of bonded assemblies between the corrosion resistant member 30 and the electric wire cover member 12 (pp) used in each practical example, are shown.

### Comparison Examples

In comparison examples 1-1 to 1-4 and 2-1 to 2-4, materials indicated in Tables 1 and 2 were used as materials for a corrosion resistant member, and materials other than the above were the same as in the practical examples, thereby obtaining a terminal-attached electric wire of each comparison example.

Endurance Test:

The terminal-attached electric wires obtained by the above practical examples and the comparison examples were heated in air of 120° C. for 120 hours.

Estimation of Corrosion Resistant Property:

As shown in FIG. 6, the terminal-attached electric wire at an initial stage before the endurance test and the terminal-attached electric wire after endurance test in each of practical examples and comparison examples were dipped into water 51 filled in a vessel 50. After that, air was injected into the terminal-attached electric wire by a pressure of 200 kPa for a time period of 30 seconds from an end portion of the terminal-attached electric wire at a side opposite to a side having the crimping terminal connected thereto. At that time, an example in which bubbles did not leak from the crimping terminal, the corrosion resistant member and the electric wire, is marked by “OK”, but one in which bubbles leak therefrom is marked by “NG”. The results of estimation of corrosion resistant performances are also indicated in Tables 1 and 2.

TABLE 1

| | | | | | | | Peel strength | | | |
|---|---|---|---|---|---|---|---|---|---|---|
| | | | | | | | to corrosion | | | |
| | | | | | | | resistant | | Corrosion resistant | |
| | Corrosion resistant member | | | Primer | | | material | | performance | |
| | | Material | Product | | Material | | (N/mm) | | Initial | After |
| | Material | maker | name | Material | maker | Product name | Sn | PP | stage | endurance test |
| Practical | Olefin-based | Mitsui | QE060 | Denaturation | Toyo | NS2002 | 0.88 | 2.18 | OK | OK |
| example 1-1 | thermoplastic | Chemical | | polyolefin | Spinning | | | | | |
| | resin | Co., Ltd | | resin | Co., Ltd. | | | | | |
| Practical | Olefin-based | Mitsui | QE060 | Olefin resin | Semedain | PP7F | 1.56 | 2.18 | OK | OK |
| example 1-2 | thermoplastic | Chemical | | | Co., Ltd. | | | | | |
| | resin | Co., Ltd | | | | | | | | |
| Practical | Olefin-based | Mitsui | QE060 | Amine | Semedain | PPX-3 | 0.2 | 2.18 | OK | OK |
| example 1-3 | thermoplastic | Chemical | | compound | Co., Ltd. | | | | | |
| | resin | Co., Ltd | | | | | | | | |
| Comparison | Olefin-based | Mitsui | QE060 | — | — | — | 0.1 | 2.18 | NG | NG |
| example 1-1 | thermoplastic | Chemical | | | | | | | | |
| | resin | Co., Ltd | | | | | | | | |
| Comparison | Olefin-based | Mitsui | QE060 | Polyhydroxy | Load Far | LOAD Chemlok | 0.1 | 2.18 | NG | NG |
| example 1-2 | thermoplastic | Chemical | | ether-based | East | 210 | | | | |
| | resin | Co., Ltd | | | Incorporated | | | | | |
| Comparison | Olefin-based | Mitsui | QE060 | Silane | Sinetsu | Sinetsu silicone | 0.1 | 2.18 | NG | NG |
| example 1-3 | thermoplastic | Chemical | | coupling | Chemical | XBM403 | | | | |
| | resin | Co., Ltd | | agent | Industries | | | | | |
| | | | | | Co., Ltd. | | | | | |
| Comparison | Olefin-based | Mitsui | QE060 | Acrylic resin | Musashi | Panako | 0.1 | 2.18 | NG | NG |
| example 1-4 | thermoplastic | Chemical | | | Paint Co., | (Registered TM) | | | | |
| | resin | Co., Ltd | | | Ltd. | PA N894 | | | | |

TABLE 2

| | Peel strength | Corrosion | |
|---|---|---|---|
| | to corrosion | resistant | |
| | resistant | performance | |
| Corrosion resistant material | material | | After |

| | | Material | Product | Primer | | | (N/mm) | | Initial | endurance |
|---|---|---|---|---|---|---|---|---|---|---|
| | Material | maker | name | Material | Material maker | Product name | Sn | PP | stage | test |
| Practical | Styrene-based | Kuraray | CJ003N | Denaturation | Toyo Spinning | NS2002 | 0.88 | 1.3 | OK | OK |
| example 2-1 | thermoplastic | Co., Ltd. | | polyolefin | Co., Ltd. | | | | | |
| | resin | | | resin | | | | | | |
| Practical | Styrene-based | Kuraray | CJ003N | Olefin resin | Semedain | PP7F | 1.56 | 1.3 | OK | OK |
| example 2-2 | thermoplastic | Co., Ltd | | | Co., Ltd. | | | | | |
| | resin | | | | | | | | | |
| Practical | Styrene-based | Kuraray | CJ003N | Amine | Semedain | PPX-3 | 0.2 | 1.3 | OK | OK |
| example 2-3 | thermoplastic | Co., Ltd | | compound | Co., Ltd. | | | | | |
| | resin | | | | | | | | | |
| Comparison | Styrene-based | Kuraray | CJ003N | — | — | — | 0.1 | 1.3 | NG | NG |
| example 2-1 | thermoplastic | Co., Ltd | | | | | | | | |
| | resin | | | | | | | | | |
| Comparison | Styrene-based | Kuraray | CJ003N | Polyhydroxy | Load Far East | LOAD Chemlok | 0.1 | 1.3 | NG | NG |
| example 2-2 | thermoplastic | Co., Ltd | | ether-based | Incorporated | 210 | | | | |
| | resin | | | | | | | | | |
| Comparison | Styrene-based | Kuraray | CJ003N | Silane | Sinetsu Chemical | Sinetsu silicone | 0.1 | 1.3 | NG | NG |
| example 2-3 | thermoplastic | Co., Ltd | | coupling | Industries Co. | XBM403 | | | | |
| | resin | | | agent | Ltd. | | | | | |
| Comparison | Styrene-based | Kuraray | CJ003N | Acrylic resin | Musashi Paint | Panako | 0.1 | 1.3 | NG | NG |
| example 2-4 | thermoplastic | Co., Ltd | | | Co., Ltd. | (Registered TM) | | | | |
| | resin | | | | | PA N894 | | | | |

As shown in Tables 1 and 2, since terminal-attached electric wires of the examples according to the embodiment did not exhibit leakage at the initial stage or even after the endurance test, it is understood that the adhesion force between the corrosion resistant member and the crimping terminal or the electric wire cover member is large so that the electric wires are excellent in the corrosion resistant performance.

Contrary to the above, in the terminal-attached electric wires in the comparison examples, leakage of bubbles was generated from the contact interface between the corrosion resistant member and the crimping terminal. That is, it is presumed that since in each of the terminal-attached electric wires of the comparison examples, the peel strength of bonded assemblies between the corrosion resistant member and the terminal member (Sn) of the crimping terminal was less than 0.2 N/mm, the adhesion force of the corrosion resistant member to the crimping terminal was not sufficient so that leakage was generated.

### Second Embodiment

Now, referring to the drawings, a terminal-attached electric wire according to the second embodiment of the present invention will be described in detail. The components which are substantially identical with or similar to those of the first embodiment are denoted by the same reference numerals, and duplicated description is omitted.

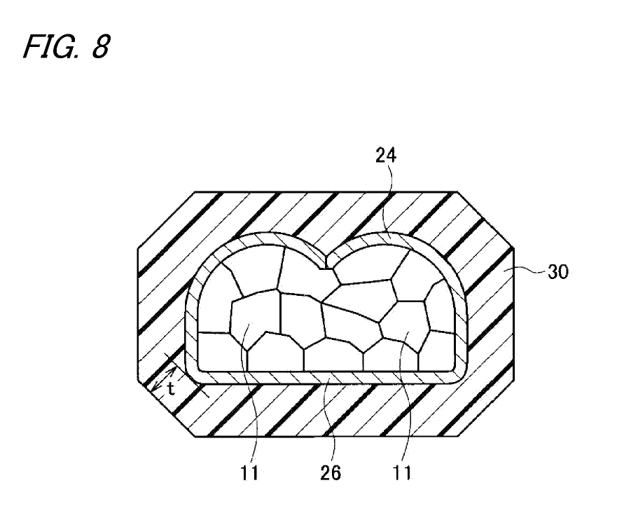

FIG. 8 is a cross sectional view of a terminal-attached electric wire according to this embodiment. As shown in FIGS. 1A, 1B, 3, 4 and 8, a terminal-attached electric wire 1 according to this embodiment includes an electric wire 10 having a conductor 11 and an electric wire cover member 12, and a crimping terminal 20 connected to the conductor 11 of the electric wire 10. The terminal-attached electric wire 1 further includes a corrosion resistant member 30 which is integrally formed with a peripheral portion of a joint section interposed between the conductor 11 and the crimping terminal 20 and a peripheral portion of the electric wire cover member 12 adjacent to the joint section. In this embodiment, the electric wire cover member 12 may be made of polyvinyl chloride (PVC).

As shown in FIG. 8, it is preferable that the thickness t of the corrosion resistant member 30 at a time when it is integrally formed with the peripheral portion of the joint section interposed between the conductor 11 and the crimping terminal 20 and the peripheral portion of the electric wire cover member 12 adjacent to the joint section, is at least equal to or greater than 0.01 mm. In a case where a sufficient sealing property can be ensured at interspaces between the corrosion resistant member 30 and the crimping terminal 20 as well as between the corrosion resistant member 30 and the electric wire cover member 12, the thickness t of the corrosion resistant member 30 can be smaller than 0.01 mm. However, when the thickness t of the corrosion resistant member 30 at the thinnermost portion is equal to or greater than 0.01 mm, it is possible to retain a sufficient strength with respect to an inner pressure of the internal section of the corrosion resistant member 30. Therefore, it is possible to prevent a corrosion causing substance from entering into the electric wire 10 for a long time period and to prevent corrosion from occurring on the joint section positioned between the conductor 11 and the crimping terminal 20.

Thus, the terminal-attached electric wire according to the embodiment is configured such that the corrosion resistant member is integrally formed with the peripheral portion of the joint section interposed between the conductor and the crimping terminal, and the peripheral portion of the electric wire cover member adjacent to the joint section.

In addition, the corrosion resistant member contains a thermoplastic elastomer as a main component.

Moreover, the peel strength of bonded assemblies between the corrosion resistant member and the terminal member of the crimping terminal is equal to or greater than 0.2 N/mm, and the peel strength of bonded assemblies between the corrosion resistant member and the electric wire cover member is equal to or greater than 0.5 N/mm.

With this, even in a case where the conductor of the electric wire and the crimping terminal are made of different metallic materials, it is possible to prevent corrosion from occurring on the materials.

That is, since it is possible to prevent a corrosion causing substance from entering into the electric wire through contact interfaces between the corrosion resistant member and the crimping terminal as well as between the corrosion resistant member and the electric wire cover member, it is possible to prevent corrosion from occurring on the joint section interposed between the conductor and the crimping terminal.

Method of manufacturing terminal-attached electric wire:

Next, a method of manufacturing a terminal-attached electric wire according to the embodiment will be described below. As shown in FIGS. 3 and 4, the terminal-attached electric wire 1 is first formed in such a manner that the terminal portion of the electric wire 10 is inserted into the electric wire joint section 22 of the crimping terminal 20. After that, the conductor 11 of the electric wire 10 is placed on the top face of the bottom plate section 26 of the conductor crimping section 24, and the portion of the electric wire 10 having the electric wire cover member 12 attached thereto is placed on the top face of the bottom plate section 28 of the cover member caulking section 25. By bending the pair of conductor caulking pieces 27 of the conductor crimping section 24 inside, the conductor 11 is caulked to be put into a state in which the conductor 11 is in intimate contact with the top face of the bottom plate section 26. In addition, by bending the pair of cover member caulking pieces 29 of the cover member caulking section 25 inside, the electric wire cover member 12 is caulked to be put into a state in which the electric wire cover member 12 is in intimate contact with the top face of the bottom plate section 28. Accordingly, the crimping terminal 20 and the electric wire 10 can be connected to each other.

Next, the joint section interposed between the crimping terminal 20 and the electric wire 10 is placed on a metallic mold. After that, the inner section of the metallic mold is filled with a resin of a corrosion resistant member which is melted by heating, and the metallic mold is cooled so as to solidify the melted resin of the corrosion resistant member. By taking it out from the metallic mold, it is possible to obtain the terminal-attached electric wire 1 configured such that the joint section interposed between the crimping terminal 20 and the electric wire 10 is covered with the corrosion resistant member 30. That is, the corrosion resistant member 30 can be formed in such a manner that the joint section interposed between the crimping terminal 20 and the electric wire 10 is placed on the metallic mold and is subjected to injection molding.

Thus, regarding the terminal-attached electric wire 1 according to the embodiment, the corrosion resistant member is formed by the injection molding. Therefore, since the shape and the thickness of the corrosion resistant member are stabilized, it is possible to retain a sufficient strength even when the thickness of the corrosion resistant member is small. In addition, since the thickness of the corrosion resistant member can be reduced, it is not necessary to change a pitch dimension of a connector housing (described later), and thereby it is possible to insert the terminal-attached electric wire 1 according to the embodiment into a connector housing having a conventional size. Consequently, it is not necessary to change a design of the connector housing for the terminal-attached electric wire 1 according to the embodiment.

Wire Harness:

A wire harness of this embodiment is provided with the above described terminal-attached electric wire 1. To be specific, a wire harness 2 according to the embodiment is provided with a connector housing 40 and the above described terminal-attached electric wires 1 as shown in FIG. 5.

A plurality of counter-side terminal attachment sections (not shown) to which counter-side terminals (not shown) are to be attached, are provided at a front face side of the connector housing 40. A plurality of terminal storage sections 41 are provided at a back face side of the connector housing 40. The crimping terminal 20 and the corrosion resistant member 30 in the terminal-attached electric wire 1 are attached to each of the terminal storage sections 41. The crimping terminals 20 are attached to the connector housing 40 and the electric wires 10 are drawn from the back face side of the connector housing 40.

As described in the above, since the thickness of the corrosion resistant member 30 in the terminal-attached electric wire 1 according to the embodiment can be reduced, it is not necessary to dare to change the pitch dimension of the connector housing 40. Therefore, the terminal-attached electric wire 1 according to the embodiment can be inserted into a connector housing having a conventional size so that it is not necessary to dare to change a design of the connector housing for the above described terminal-attached electric wire 1.

### EXAMPLES

The invention is described below in detail on the basis of practical examples and comparison examples. However, the invention is not limited by the practical examples.

### Practical Examples 1 to 3

Regarding practical examples 1 to 3, materials for the corrosion resistant member 30 shown in Table 3 were first prepared. An electric wire having a conductor made of aluminum and an electric wire cover member made of polypropylene (pp) was prepared. A crimping terminal with the use of tin plated copper as a terminal member was prepared.

Next, the electric wire 10 and the crimping terminal 20 were connected to each other, and then a joint section interposed between the crimping terminal 20 and the electric wire 10 was placed on a metallic mold. After that, the inner section of the metallic mold was filled with a material of the corrosion resistant member 30 of each practical example, the material being melted by heating, and the metallic mold was cooled, and thereby the melted material of the corrosion resistant member 30 was solidified. By taking it out from the metallic mold, the terminal-attached electric wire 1 of each practical example was obtained. Meanwhile, in Table 3, a peel strength of bonded assemblies between the corrosion resistant member 30 to the terminal member (tin) of the crimping terminal 20 and a peel strength of bonded assemblies between the corrosion resistant member 30 and the electric wire cover member 12 (pp) used in each practical example, are shown.

### Comparison examples 1 and 2

In comparison examples 1 and 2, materials indicated in Table 3 were used as materials for a corrosion resistant member, and materials other than the above were the same as in the practical examples 1 to 3, thereby obtaining a terminal-attached electric wire of each comparison example.

Endurance Test:

The terminal-attached electric wires obtained by the above practical examples 1 to 3 and the comparison examples 1 and 2 were heated in air of 120° C. for 120 hours.

Estimation of Corrosion Resistant Property:

As shown in FIG. 6, the terminal-attached electric wire at an initial stage before the endurance test and the terminal-attached electric wire after endurance test in each of practical examples and comparison examples were dipped into water 51 filled in a vessel 50. After that, air was injected into the terminal-attached electric wire by a pressure of 200 kPa for a time period of 30 seconds from an end portion of the terminal-attached electric wire at a side opposite to a side having the crimping terminal connected thereto. At that time, an example in which bubbles did not leak from the crimping terminal, the corrosion resistant member and the electric wire, is marked by “OK”, but one in which bubbles leak therefrom is marked by “NG”. The results of estimation of corrosion resistant performances are also indicated in Table 3.

TABLE 3

| | | | | Peel strength | | | |
|---|---|---|---|---|---|---|---|
| | | | | to corrosion | | Corrosion | |
| | | | | resistant | | resistant | |
| | Corrosion resistant member | | | material | | performance | |
| | | Material | Product | (N/mm) | | Initial | After |
| | Material | maker | name | Sn | PP | stage | endurance test |
| Practical | Olefin-based | Aronkasei | AR-9020N | 2.65 | 2.02 | OK | OK |
| example 1 | thermoplastic | Co., Ltd | | | | | |
| | resin | | | | | | |
| Practical | Styrene-based | Kuraray | Septon | 1.59 | 4.07 | OK | OK |
| example 2 | thermoplastic | Co., Ltd | V9461 | | | | |
| | resin | | | | | | |
| Practical | Polyester-based | Toyobo | Vyloshot | 1.56 | 0.88 | OK | OK |
| example 3 | thermoplastic | Co., Ltd | GM-955- | | | | |
| | resin | | RK20 | | | | |
| Comparison | Olefin-based | Mitsui | Admer | 0.10 | 2.18 | NG | NG |
| example 1 | thermoplastic | chemical | QE090 | | | | |
| | resin | Co., Ltd | | | | | |
| Comparison | Polyester-based | Toyobo | Pelprene | 2.18 | 0.35 | NG | NG |
| example 2 | thermoplastic | Co., Ltd | P-40HMA | | | | |
| | resin | | | | | | |

As shown in Table 3, since terminal-attached electric wires of the examples 1 to 3 according to the embodiment did not exhibit leakage at the initial stage or even after the endurance test, it is understood that the adhesion force between the corrosion resistant member and the crimping terminal or the electric wire cover member is large so that the electric wires are excellent in the corrosion resistant performance.

Contrary to the above, in the comparison example 1, leakage of bubbles was generated through the contact interface between the corrosion resistant member and the crimping terminal.

That is, regarding the terminal-attached electric wire of the comparison example 1, since the peel strength of the bonded assemblies between the corrosion resistant member and the terminal member (Sn) of the crimping terminal was smaller than 0.2 N/mm, it is presumed that the adhesion force between the corrosion resistant member and the crimping terminal was insufficient so that the leakage was generated.

Similarly to the above, regarding the comparison example 2, leakage of bubbles through the contact interface between the corrosion resistant member and the electric wire cover member is generated. That is, regarding the terminal-attached electric wire of the comparison example 2, since the peel strength of bonded assemblies between the corrosion resistant member and the electric wire cover member (PP) was smaller than 0.5 N/mm, it is presumed that the adhesion force between the corrosion resistant member and the electric wire cover member was insufficient so that the leakage was generated.

It is apparent that various modifications can be made in the invention within a scope not deviating from the gist of the invention.

For example, though the primer 31 is not used in the second embodiment as described above, the primer may be partly used at the interspace between the corrosion resistant member and the joint section interposed between the conductor and the crimping terminal in such a way that the primer is applied to whole circumference of metal parts.

The present invention is useful for providing a terminal-attached electric wire which is configured to prevent corrosion from occurring on a joint section interposed between an electric wire and a crimping terminal for a long time period.

What is claimed is:

1. A terminal-attached electric wire comprising:
an electric wire having a conductor and an electric wire cover member covering the conductor;
a crimping terminal connected to the conductor of the electric wire;
a corrosion resistant member which is integrally formed with a peripheral portion of a joint section interposed between the conductor and the crimping terminal and a peripheral portion of the electric wire cover member adjacent to the joint section; and
a primer provided at an interspace between the corrosion resistant member and the joint section interposed between the conductor and the crimping terminal, wherein
the corrosion resistant member contains a thermoplastic elastomer as a main component, a peel strength of bonded assemblies between the corrosion resistant member and a terminal member of the crimping terminal is equal to or greater than 0.2 N/mm.

2. The terminal-attached electric wire according to claim 1, wherein
a peel strength of bonded assemblies between the corrosion resistant member and the electric wire cover member is equal to or greater than 0.5 N/mm.

3. The terminal-attached electric wire according to claim 1, wherein
the conductor is made of aluminum or aluminum alloy;
the terminal member of the crimping terminal is made of at least one of copper, copper alloy, stainless steel, tin plated copper, tin plated copper alloy and tin plated stainless steel; and
the electric wire cover member is made of at least one of polyethylene, polypropylene, ethylene copolymer and propylene copolymer.

4. The terminal-attached electric wire according to claim 1, wherein
the primer contains, as a main component, at least one of an olefin resin, an amine compound, a silane coupling material and an epoxy-based component.

5. A wire harness comprising:
the terminal-attached electric wire according to claim 1.

6. A method of manufacturing a terminal-attached electric wire, comprising:
a process of connecting an electric wire having a conductor and an electric wire cover member covering the conductor to a crimping terminal connected to the conductor of the electric wire;
a process of applying a primer to a joint section interposed between the conductor and the crimping terminal; and
a process of forming, by injection molding, a corrosion resistant member at a peripheral portion of the joint section interposed between the conductor and the crimping terminal, the joint section being coated with the primer, and a peripheral portion of the electric wire cover member adjacent to the joint section, wherein
the corrosion resistant member contains a thermoplastic elastomer as a main component, and
a peel strength of bonded assemblies between the corrosion resistant member and a terminal member of the crimping terminal is equal to or greater than 0.2 N/mm.

7. The method of manufacturing a terminal-attached electric wire according to claim 6, wherein
a peel strength of bonded assemblies between the corrosion resistant member and the electric wire cover member is equal to or greater than 0.5 N/mm.

8. A terminal-attached electric wire comprising:
an electric wire having a conductor and an electric wire cover member covering the conductor;
a crimping terminal connected to the conductor of the electric wire; and
a corrosion resistant member which is integrally formed with a peripheral portion of a joint section interposed between the conductor and the crimping terminal and a peripheral portion of the electric wire cover member adjacent to the joint section, wherein
the corrosion resistant member contains a thermoplastic elastomer as a main component, a peel strength of bonded assemblies between the corrosion resistant member and a terminal member of the crimping terminal is equal to or greater than 0.2 N/mm.

9. The terminal-attached electric wire according to claim 8, wherein
a peel strength of bonded assemblies between the corrosion resistant member and the electric wire cover member is equal to or greater than 0.5 N/mm.

10. The terminal-attached electric wire according to claim 8, wherein
the conductor is made of aluminum or aluminum alloy;
the terminal member of the crimping terminal is made of at least one of copper, copper alloy, stainless steel, tin plated copper, tin plated copper alloy and tin plated stainless steel; and
the electric wire cover member is made of polyvinyl chloride.

11. A wire harness comprising:
the terminal-attached electric wire according to claim 8.

12. A method of manufacturing a terminal-attached electric wire, comprising:
a process of connecting an electric wire having a conductor and an electric wire cover member covering the conductor to a crimping terminal connected to the conductor of the electric wire; and
a process of forming, by injection molding, a corrosion resistant member at a peripheral portion of the joint section interposed between the conductor and the crimping terminal, and a peripheral portion of the electric wire cover member adjacent to the joint section, wherein
the corrosion resistant member contains a thermoplastic elastomer as a main component, and
a peel strength of bonded assemblies between the corrosion resistant member and a terminal member of the crimping terminal is equal to or greater than 0.2 N/mm.

13. The method of manufacturing a terminal-attached electric wire according to claim 12, wherein
a peel strength of bonded assemblies between the corrosion resistant member and the electric wire cover member is equal to or greater than 0.5 N/mm.
